(19) United States
(12) Patent Application Publication
(10) Pub. No.: US 2002/0126625 A1
(43) Pub. Date: Sep. 12, 2002

(54) Apparatus and method for automated fiber connection discovery and diagnostics

(76) Inventors: Ling-Zhong Liu, Ottawa (CA); Jim Jincheng Xu, Kanata (CA); Donald Asquin, Ottawa (CA)

Correspondence Address: MARKS & CLERK, P.O. BOX 957, STATION B, OTTAWA, ON, K1P 5S7, CA

(21) Appl. No.: 10/091,290

(22) Filed: Mar. 6, 2002

Related U.S. Application Data
(60) Provisional application No. 60/274,612, filed on Mar. 12, 2001.

(51) Int. Cl. H04L 12/28

(52) U.S. Cl. 370/254; 370/410

(57) ABSTRACT

The invention proposes an apparatus and method to automatically discover port mapping between neighboring optical nodes in a switched optical network. It can also be used as a diagnostic method to find faulty connections and channels. It is assumed that each node has a switch that can connect any ingress port to any egress port in the node.

This invention claims the benefit of U.S. Provisional Application No. 60/274,612 filed Mar. 12, 2001.

### FIELD OF THE INVENTION

This invention relates to communications systems and more particularly to the network management of communications systems involving switched optical networks.

### BACKGROUND

In a switched optical network, typically, two neighboring nodes are physically connected by a bundle of optical fibers. At each node, each optical fiber within the bundle is identified as a port and assigned a unique port number. When two nodes are interconnected by optical fibers, it is necessary to make sure that the ports in one node are mapped to the ports in the other node as required. There is a possibility that some optical fibers are incorrectly connected to the wrong ports. It is also possible that there are some connection failures or faults. Accordingly there is a need for a system to automatically discover fiber connections in a switched optical network. Also, the discovery mechanism can, preferably, provide a diagnostic function.

### SUMMARY OF THE INVENTION

The present invention provides an apparatus and method for automatically discovering port mapping. It can also be used as a diagnostic method to find faulty connections and channels. In the following description it is assumed that each node has a switch that can connect any ingress port to any egress port in the node. The system employs a handshaking protocol comprising a series of discovery and acknowledgement messages. Additionally, once the ports have established connectively, performance testing can determine the quality of the connection.

According to a broad aspect of the invention there is provided a handshaking protocol to automatically discover fiber connections in a switched optical network and to provide diagnostics for fault connections on two neighboring optical nodes.

### BRIEF DESCRIPTION OF THE DRAWINGS

The invention will now be described in greater detail with reference to the attached drawings wherein:

FIG. 1 is a diagram of two optical nodes connected by a bundle of optical fibers;

FIG. 2 illustrates a handshaking sequence;

FIG. 3 is a flow diagram of the algorithm implemented on the receiving node;

FIG. 4 is a flow diagram of the algorithm implemented on the sending node;

FIG. 5 illustrates the message format for connect, reply and confirmation;

FIG. 6 is a diagram of two optical nodes connected with a bundle of optical fibers using a Bit Error Rate Test Set (BERTS) to determine quality of the connection; and

FIG. 7 is a diagram of two optical nodes driven by a specific Synchronous Optical Network (SONET) payload to determine the quality of the connection.

### DETAILED DESCRIPTION OF THE INVENTION

In a switched optical network as contemplated by the present invention, two neighboring nodes are physically connected by a bundle of optical fibers. At each node, individual fibers are identified as a port and are assigned a port number. It is, of course, desirable to make sure that each port in one node is mapped to a connected port in the other node.

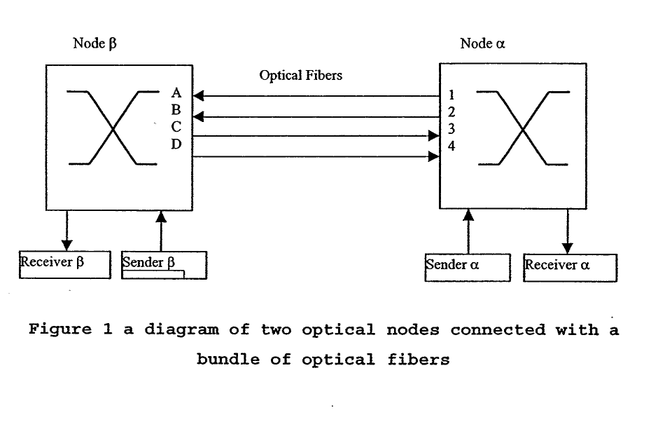

FIG. 1 shows the basic concept of two nodes α and β connected by a bundle of fibers. Each node has several ingress ports and several egress ports, numbered 1, 2,3,4, A, B, C and D in FIG. 1. In this exemplary embodiment two ingress ports and two egress ports are shown for each node. It is. to be understood that in a practical implementation there will be many of each type of nodes. It is possible that an ingress port is paired with an egress port, and the two ports are assigned to the same port number. However the invention is independent in relation to the numbering scheme as long as the scheme can uniquely identify each port.

Each egress port is physically connected to an ingress port of its neighboring node by an optical fiber. In the following discussion these ports are known as a Connection Port Pair (CPP). The discovery function, according to the invention, is to find the CPP pair for each port in a node. In the invention, port-mapping discovery is performed by exchanging Connection Discovery Messages (CDM) between the two CPP ports.

In a Wavelength Division Multiplex (WDM) system, there may be multiple wavelengths transported through a single fiber. However, to discover the mapping for each CPP, only one wavelength is needed for exchanging CDMs. A default wavelength is defined and agreed upon by all nodes for exchanging the CDMs. Normally the longest wavelength is chosen and is called a CDM channel.

The connection discovery process is triggered by an operator. The operator may initiate the discovery process for all the fiber ports, or only some specified ports inside the node. Once the process starts, the node begins to send the CDMs to all or some of its specified egress port using the CDM channels. Additionally, each node has a receiver that is connected to each of its specified ingress ports to wait for a CDM on the CDM channels. A rotation or scanning mechanism to scan all specified ingress and egress ports is described later.

The CDM format includes the node name and the sending port number. Once a node receives a CDM, it embeds its node name, receiving port and reply or send port numbers, together with the originator's sending port number into the reply CDM and sends back the reply message. When this reply message reaches the original sender, the original sender knows which pair of the fibers is connected to it. It then sends back the reply CDM through its original sending port. This reply CDM embeds additional receiving port number information. When the other node receives this CDM, it knows which pair of the fibers is connecting to it as well. It then sends back a reply CDM to the sender to let the sender know that it knows the connections. The original sender replies to this CDM to let the original receiver know that it also knows the connections. The receiver then sends back a reply CDM to finish the handshaking procedure.

The detailed handshaking algorithm and the message format will now be described.

1. The Handshaking Protocol

Each node sends and receives the CDMs by connecting the spare monitoring channels to its egress or ingress ports via its switching fabric. The sending unit sends out the CDMs to each of its specified egress port and the receiver unit monitors the reply CDMs on each of its specified ingress ports. As an example, the handshaking algorithm for the system in FIG. 1 may work as following:

1) Sender α: sends out α1000 through port 1, which means the message comes from node α port 1 searching for its connected port.

2) Receiver β: receives α1000 on port A. It knows that its port A is connected to port 1 of the node α.

3) Sender β: sends out βC0A1 through port C.

4) Receive α: receives βC0A1 from port 3. Node α then knows that its port 1 is connected to port A of the node β and its port 3 is connected to port C of the node β.

5) Sender α: sends α1A3C through port 1 to node β.

6) Receiver β:receives α1A3C from port A. Node β then knows that its port A is connected to port 1 of the node α and its port C is connected to port 3 of the node α. It also knows that the node α already knows these connections.

7) Sender β: sends out βC3A1 through port C to node α.

8) Receiver α: receives βC3A1 from port 3. Node α then knows that node β knows the connection as well.

9) Sender α: sends α1A3C through port 1 to node β for confirmation.

A) Receiver β: receives α1A3C from port A. Receiver β knows that node a is requiring confirmation.

B) Sender β: sends out βC3A1 through port C to node α for confirmation and updates node β's connection mapping table.

C) Receiver α: receives βC3A1 from port 3, and updates node α's connection mapping table.

To avoid missing CDMs, the sender at each node preferably scans each of its specified egress port at a relatively fast speed. On the other hand, the receiver at each node should scan each of its specified ingress port at a slower speed. At least the receiver should stay monitoring one ingress port until the sender has finished scanning all of its egress ports.

Once a receiver receives a CDM, the node should stop scanning the egress port to send CDMs. It should focus on replying to the CDM. On the other hand, once a sender receives a reply CDM, it should stop scanning and focus on dealing with this reply CDM until a connection is confirmed or timed out.

If in step 6) above the receiver β cannot obtain the acknowledgement CDM from node α, it knows that the reply channel has something wrong. Node β should choose another egress port to send out an error message to node α. It should also raise an alarm showing this egress port error.

If in step 4) the receiver a cannot receive a reply CDM after a certain amount of time, it should raise an alarm showing the connection error.

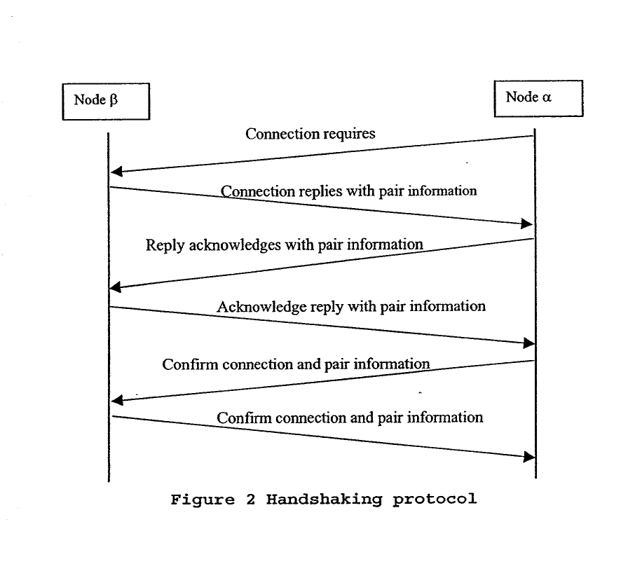

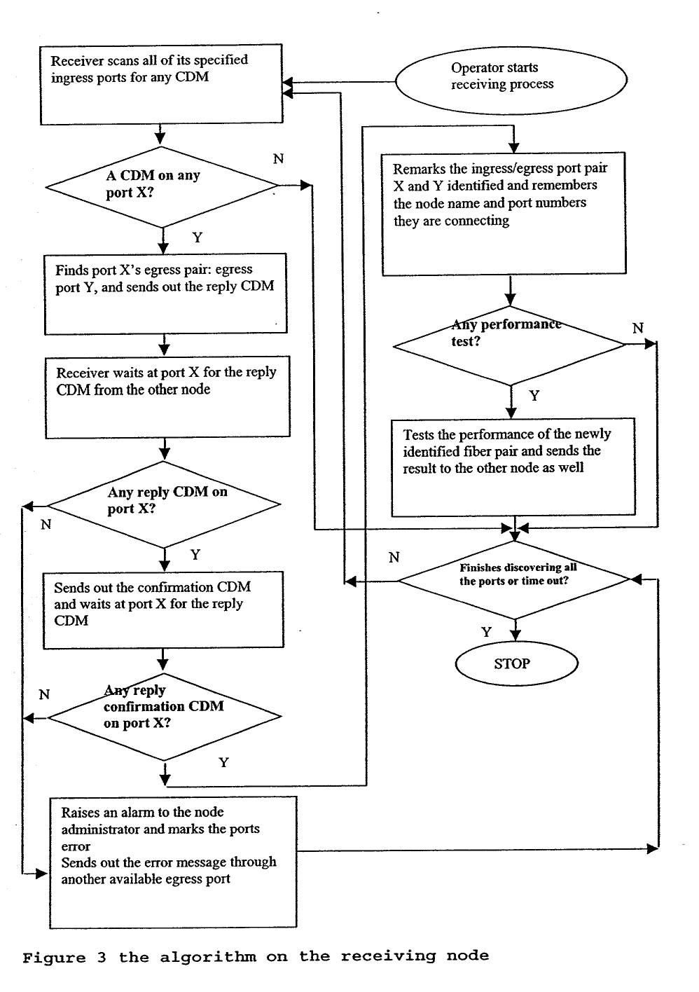

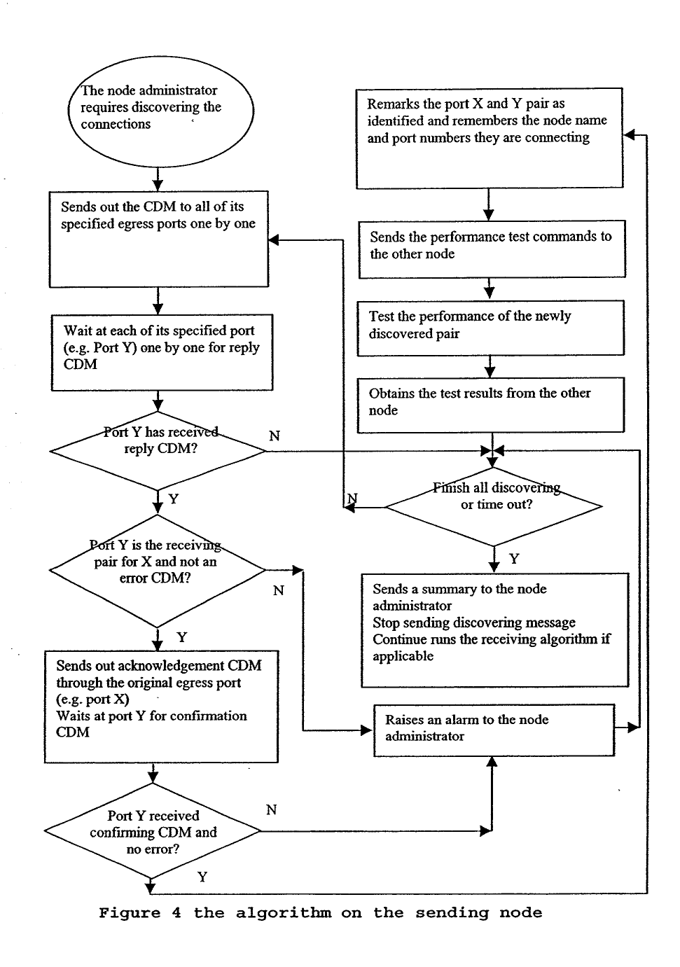

FIG. 2 shows the handshaking algorithm. The algorithm can be summarized using the flowcharts shown in FIGS. 3 and 4. Both the sending and receiving algorithms may run on the two neighboring nodes. Once a node is receiving a CDM, it will focus on the receiving algorithm and its peer node should focus on the sending algorithm. The node administrators/ operators may also initiate one node to run the sending algorithm and the other one to run the receiving algorithm.

Once connectivity has been established, performance testing can be initiated to determine the quality of the connection. FIG. 6 shows a Bit Error Rate Test Set (BERTS) 61, either internal or external, connected to Node β 63. The test pattern is routed through the node to an output port, in this case “D”. The test pattern travels down the fiber 64 to the port on Node α 65, in this case “4”. Node α 65 loops the signal back to one of its output ports, in this case “1”, across the optical fiber 66 to Node β 63, in this case, port “A”. The test pattern is routed through Node β back to the BERTS 61. The BERTS can determine the error rate of the looped back signal and indicate to the user if there is a problem with one of the components (Transmitter, Fiber, Receiver) the connection path.

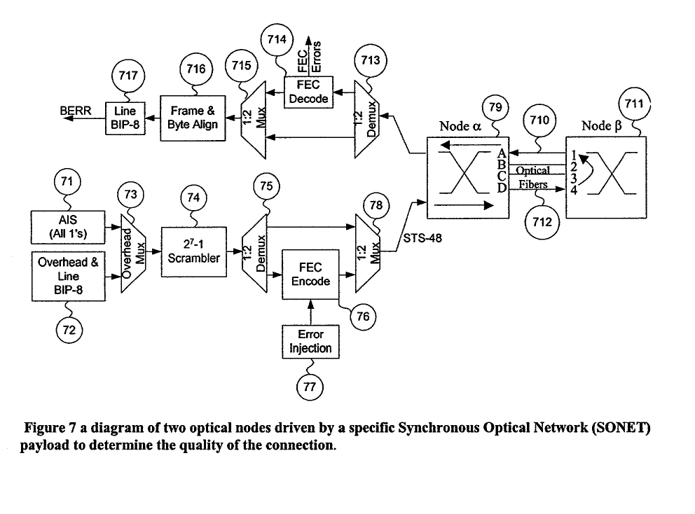

Alternately a specific Synchronous Optical Network (SONET) payload can be used to determine the quality of the connection. FIG. 7 shows an all 1's Line Alarm Indication Signal (AIS) 71 being multiplexed 73 with the SONET overhead and Line Bit Interleaved Parity 8 (BIP-8) 72. The resulting data pattern is scrambled in a 2⁷-1 scrambler 74. The scrambled data can optionally have Forward Error Correction (FEC) added through a 1:2 Demultiplexer (Demux) 75, 1:2 Multiplexer (Mux) 78 and a FEC Encoder 76. Errors can be injected 77 into the FEC. The SONET Synchronous Transport Signal 48 (STS-48) is connected to Node β 79. The test pattern is routed through the node to an output port, in this case “D”. The test pattern travels down the fiber 712 to the port on Node α 711, in this case “4”. Node α 711 loops the signal back to one of its output ports, in this case “1”, across the optical fiber 710 to Node β 79, in this case, port “A”. The test pattern is routed through Node β 79. Optionally, FEC coding can be decoded and FEC errors detected through a 1:2 Demultiplexer (Demux) 713, 1:2 Multiplexer (Mux) 715 and a FEC Decoder 714. The SONET frame is then Frame and Byte Aligned 716 and the Bit Error Rate (BER) detected through errors in the Line BIP-8 717. This can determine the error rate of the looped back signal and indicate to the user if there is a problem with one of the components (Transmitter, Fiber, Receiver) the connection path. Line BIP-8 is a standard method of error detection in a SONET network.

2. Connect Discovery Message (CDM) format

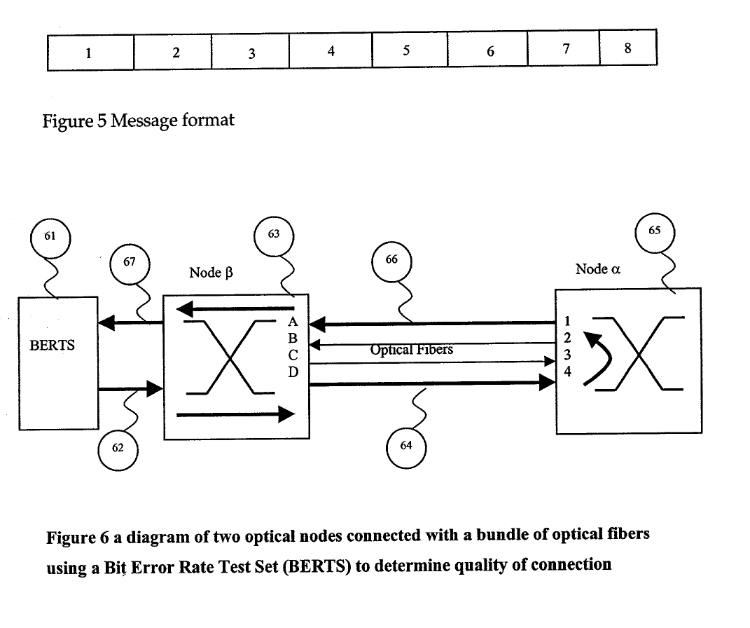

FIG. 5 shows the message format for the connect requirement, reply and confirmation. The definition of each field is described as following:

1. Synchronization header.

2. Message type (e.g. discovery, reply, acknowledgement, confirmation, testing, error).

3. Node name which is sending this message.

4. Egress port number which is sending this message.

5. Ingress port number who should receive this message. 0 means do not know.

6. Ingress port number on the sending node which should receive the reply message. 0 means do not know.

7. Egress port number which should send back reply message. 0 means do not know.

8. Error checking field.

The following possible variation is contemplated by the invention:

The relationship of the two connected optical nodes may be varied such that the two nodes may run the same algorithm or one node may act as the master and the other node as slave.

A particular advantage of the invention is that it provides automatic discovery and diagnostics, and that it automatically provides performance testing between the two nodes.

While particular embodiments of the invention have been described and illustrated it will be apparent to one skilled in the art that numerous changes can be made without departing from the basic concept. It is to be understood that such changes will fall within the full scope of the invention as defined by the appended claims.

We claim:

1. A method of automatically discovering port mapping between neighboring optical nodes in a switched optical network, the method employing a handshaking protocol between the nodes to discover fiber connections therebetween.

2. The method according to claim 1 wherein said handshaking protocol performs connection fault diagnostics.

3. The method according to claim 1 wherein said handshaking protocol includes the transfer of connection discovery messages.

4. The method according to claim 1 wherein said handshaking protocol is transferred between the nodes utilizing a dedicated wavelength channel.

5. The method according to claim 3 wherein said connection discovery messages include connected port pair (CPP) information.

6. The method according to claim 5 wherein said CPP information includes node name and port number.

7. The method according to claim 5 wherein said CPP information includes connection status information.

8. The method according to claim 5 wherein said CPP information includes diagnostic information.

9. The method according to claim 1 wherein a receiver unit at each node scans each specified ingress port for incoming connection discovery messages.

10. The method according to claim 9 wherein the receiving unit monitors an ingress port until a sender unit at the node finishes scanning of egress ports on the node.

11. A system for automatically discovering port mapping between neighbouring optical nodes in a switched optical network comprising a sender unit at each node for sending a connection discovery message to said other node, and a receiver unit at each node for receiving a connection discovery message for said other node, whereby connection port pair information is encoded into said messages.

12. The system according to claim 11 wherein said neighbouring optical nodes are interconnected via a bundle of optical fibers.

13. The system according to claim 12 wherein each node has a plurality of ports, with an optical fiber connecting ports on respective nodes.

14. The system according to claim 13 wherein each port has a port name and a unique port number.

15. The system according to claim 14 wherein each sender unit and each receiver unit sends and receives connection discovery messages over a message channel.

16. The system according to claim 15 wherein each node has scanning means to send messages to selected ports over said message channel.

17. The system according to claim 12 wherein said optical nodes have performance testing functionality to determine quality of the connection between said optical nodes.

18. The system according to claim 17 wherein said performance testing functionality is provided by a Bit Error Rate Test Set (BERTS).

19. The system according to claim 17 wherein said performance testing functionality is provided by a Synchronous Optical Network (SONET) pay load.
